(19) United States
(12) Patent Application Publication
(10) Pub. No.: US 2025/0124391 A1
(43) Pub. Date: Apr. 17, 2025

(54) EVALUATING TOPIC TREATMENT IN ELECTRONIC COMMUNICATIONS

(71) Applicant: Highspot, Inc., Seattle, WA (US)

(72) Inventors: Kurt William Berglund, Kirkland, WA (US); Md Tanvir Islam Aumi, Redmond, WA (US); Oliver Sharp, Seattle, WA (US); Robert Wahbe, Seattle, WA (US); William Dinkel, Seattle, WA (US)

(21) Appl. No.: 18/919,303

(22) Filed: Oct. 17, 2024

Related U.S. Application Data
(60) Provisional application No. 63/591,035, filed on Oct. 17, 2023.

(51) Int. Cl. G06Q 10/0639; H04L 12/18

(52) U.S. Cl. CPC G06Q 10/06395; G06Q 10/06393; G06Q 10/06398; H04L 12/1831

(57) ABSTRACT

A content management platform generates an interactive user interface that correlates (i) user interaction data associated with content items maintained by a content management platform, against (ii) treatment of topics during meetings that are recorded in meeting recording files stored by the content management platform. The platform assigns a topic assessment metric to meeting recording files by matching a vector representation of a portion of the file to a vector representation of a candidate topic. A scoring model can then be applied to the portion of the file to assess how the candidate topic was treated during the meeting. The platform can also capture use data that describes how users interact with information items maintained by the platform. A subset of this use data and the topic assessment metrics are populated into the user interface.

### CROSS-REFERENCE TO RELATED APPLICATION

This application claims the benefit of U.S. Provisional Patent Application No. 63/591,035, filed Oct. 17, 2024, which is incorporated herein by reference in its entirety.

### BACKGROUND

Electronic communications have become ubiquitous in workplaces, schools, and other types of organizations. As people in the organization use electronic communication to distribute information within the organization or with others outside the organization, it can be difficult to determine which information has been provided and the effectiveness of this information to achieve certain goals. This difficulty is compounded when the information is distributed through videoconferences, telephone calls, or other non-written communications.

### BRIEF DESCRIPTION OF THE DRAWINGS

Detailed descriptions of implementations of the present invention will be described and explained through the use of the accompanying drawings.

FIG. 1 is a block diagram illustrating an environment in which a content management platform operates, according to some implementations.

FIG. 2 is a flowchart illustrating a process for evaluating treatment of specified topics in meetings and measuring corresponding impacts of the treatment, according to some implementations.

FIGS. 3A-3B illustrate example scorecards that can be generated by the platform.

FIG. 4 is a flowchart illustrating a process for identifying topics discussed during meetings, according to some implementations.

FIG. 5 is a flowchart illustrating a process for identifying content that is shared during meetings, according to some implementations.

FIG. 6 is a flowchart illustrating a process for matching content pages identified in a videoconference to specific content items in a content repository, according to some implementations.

FIG. 7 is a data flow diagram illustrating a process for scoring topic treatments, according to some implementations.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A content management platform manages information within an organization and can facilitate interactions between users within the organization and outside the organization. These interactions can include electronic communications across any of a variety of channels, including, for example, video calls, audio calls, emails, instant messages, or file sharing. Many of these communications can be used to convey information that is relevant to a goal of the organization. For example, a company that is offering a product or service for sale often desires to communicate information about this product or service to its potential and current customers for goals such as increasing sales or improving customer retention. In another example, an educational institution may desire to communicate information to students to achieve goals such as improving students' test scores or increasing graduation rates.

For many types of electronic communications, it can be difficult for an organization to assess the information that has been provided in the communications and whether the way this information is communicated is effective to achieve certain goals. For example, if a company's sales representative discusses certain information about a product in a telephone call or videoconference with a potential customer, it is difficult for the company to confirm whether the information was conveyed to the customer at all, much less to evaluate how well the salesperson conveyed this information. It becomes even more difficult to determine the information that has been conveyed, and how well it has been conveyed, in an environment where many different communications channels are used.

To solve these problems, the content management platform according to implementations herein processes electronic communications, including audio- and video-based communications, to evaluate when and how certain topics are addressed in these communications. Topics can include, for example, a particular slide or content item to be shared, a concept to be discussed, a word or phrase to be used, or a product to be demonstrated. The content management platform can use a vector search and a large language model to determine when topics are addressed in an electronic communication and to assign a qualitative or quantitative score to the treatment of the topic in the communication. The topics and their scores can be aggregated over time to generate a scorecard that correlates topic treatment to goals of the organization. These topics can be correlated against use data that describes how users are interacting with information items in the organization. As a result, the content management platform creates a scalable and flexible tool for evaluating an organization's communication goals against its actual performance. The interactive user interface unifies disparate communication types, enabling an organization to evaluate how well its users are communicating about topics across potentially multiple different communication channels.

According to some implementations herein, a content management platform generates an interactive user interface that correlates (i) user interaction data associated with content items maintained by a content management platform, against (ii) treatment of topics during meetings that are recorded in meeting recording files stored by the content management platform. The platform assigns a topic assessment metric to meeting recording files by matching a vector representation of a portion of the file to a vector representation of a candidate topic. A scoring model can then be applied to the portion of the file to assess how the candidate topic was treated during the meeting. The platform can also capture use data that describes how users interact with information items maintained by the platform. A subset of this use data and the topic assessment metrics are populated into the user interface. For example, a user can opt to populate data associated with certain topics, data associated with meetings held during a certain time period, or data associated with certain users.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### I. Content Management Platform

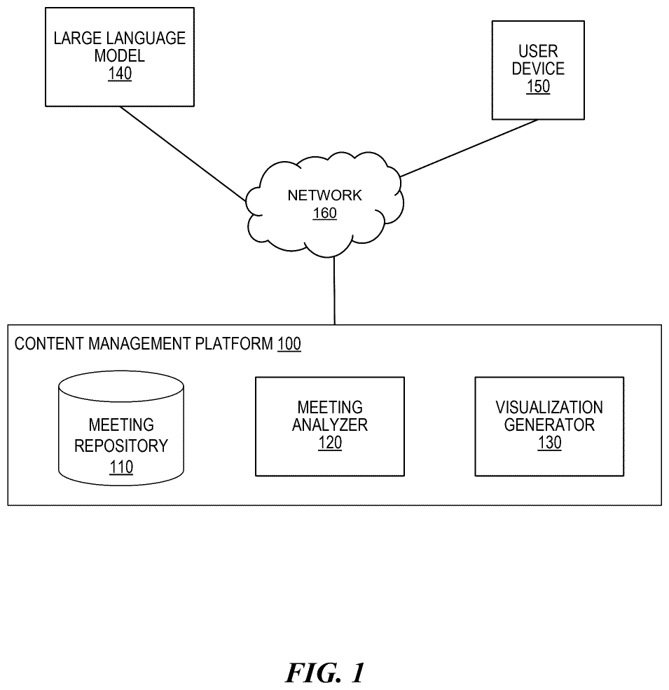

FIG. 1 is a block diagram illustrating an environment in which a content management platform 100 operates. As shown in FIG. 1, the environment can include the content management platform 100, a large language model (LLM) 140, and one or more user devices 150, which can communicate with each other over a network 160 such as the Internet.

The content management platform 100 is a platform associated with an organization to facilitate creation, storing, sharing, and tracking of the organization's content. Users within the organization can use any of a variety of modes of electronic communication to interact with each other and/or with people outside the organization, such as customers or potential customers, students, or collaborators. The content management platform 100 can facilitate or ingest data associated with these electronic communications to help manage and track the organization's activities.

Some of the electronic communications facilitated or ingested by the content management platform 100 include audio or videoconferencing communications. These communications are referred to generally herein as “meetings,” although they may include synchronous, asynchronous, or a combination of synchronous and asynchronous communications between two or more participants. The content management platform 100 maintains a meeting repository 110 that stores data associated with these communications, such as recordings of the meetings, transcripts of the meetings, and/or meeting metadata such as a list of attendees, a title of the meeting, meeting time, or an identification of any content shared during the meeting.

The content management platform 100 also includes subsystems to process meeting data to generate insights about the meetings themselves and/or outcomes of the meetings. As shown in FIG. 1, these subsystems can include a meeting analyzer 120 and a visualization generator 130.

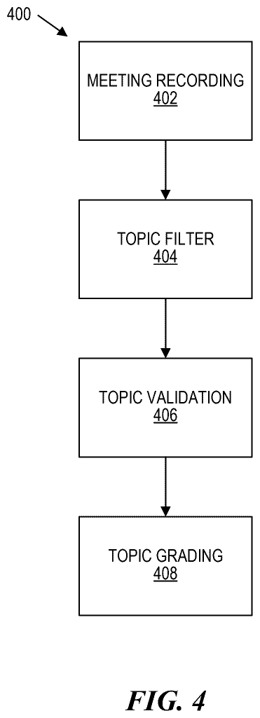

The meeting analyzer 120 processes meeting recordings or transcripts to determine when the meetings address certain topics. The meeting analyzer 120 can process any communication during a meeting, such as words spoken by meeting attendees, content items shared during a meeting, items typed in a meeting chat or written (e.g., on a virtual whiteboard), or hand gestures or other non-verbal communication during a meeting. For each topic identified as having been addressed in a meeting, the meeting analyzer 120 can generate quantitative or qualitative evaluations of the topic's treatment. The meeting analyzer 120 is described further with respect to FIGS. 4-7.

The visualization generator 130 receives topic treatment data from the meeting analyzer 120 and uses the data to generate a “scorecard,” or visual representation of the topic treatment data. The visualization generator 130 can maintain the topic treatment data, linked to the user who presented the topic, other users who attended each meeting, and a date of the meeting. The topic treatment data can be aggregated across a period of time and/or between multiple users and can be correlated to certain goals or outcomes of an organization.

Some implementations of the content management platform 100 can further enable access to content items in a content repository. The platform 100 can provide user interfaces via a web portal or application, which are accessed by the user devices to enable users to create content items, view content items, share content items, or search content items. In some implementations, the content management platform 100 includes enterprise software that manages access to a company's private data repositories and controls access rights with respect to content items in the repositories. However, the content management platform 100 can include any system or combination of systems that can access a repository of content items, whether that repository stores private files of a user (e.g., maintained on an individual's hard drive or in a private cloud account), private files of a company or organization (e.g., maintained on an enterprise's cloud storage), public files (e.g., a content repository for a social media site, or any content publicly available on the Internet), or a combination of public and private data repositories.

Content items stored in a content repository maintained by the content management platform 100 can include items such as documents, videos, images, audio recordings, 3D renderings, 3D models, or immersive content files (e.g., metaverse files). Documents stored in the content repository can include, for example, technical reports, sales brochures, books, web pages, transcriptions of video or audio recordings, presentations, or any other type of document. In some implementations, the content management system enables users to add content items in the content repository to a person collection of items. These collections, referred to herein as “spots,” can include links to content items in the content repository, copies of items in the content repository, and/or external content items (or links to external content items) that are not stored in the content repository. Users can create spots for their own purposes (e.g., to keep track of important documents), for organizing documents around a particular topic (e.g., to maintain a set of documents that are shared whenever a new client is onboarded), for sharing a set of documents with other users, or for other purposes. In some cases, users may be able to access the spot created by other users.

The content management platform 100 can provide interfaces for users to interact with content in the content repository, such as interfaces that enable users to view, create, modify, or share content items. Alternatively, the content management platform 100 maintains a set of APIs that enable other services, such as a native filesystem on a user device, to access the content items in the content repository and facilitate user interaction with the content items.

The content management platform 100 can maintain use data quantifying how users interact with the content items in the content repository. Use data for a content item can include, for example, a number of users who have viewed the item, user dwell time within the item (represented as dwell time in the content item overall and/or as dwell time on specific pages or within particular sections of the content item), number of times the item has been shared with internal or external users, number of times the item has been presented during a videoconference, number of times the item has been bookmarked by a user or added to a user's collection of documents (a “spot”), number of times an item has been edited, type and nature of edits, etc. When the content repository stores files of a company or organization, the use data can be differentiated according to how users inside the company or organization interact with the content and how users outside the company or organization interact with it.

In an example use case, the content management platform 100 is a sales enablement platform. The platform can store various items that are used by a sales team or their customers, such as pitch decks, product materials, demonstration videos, or customer case studies. Members of the sales team can use the platform 100 to organize and discover content related to the products or services being offered by the team, communicate with prospective customers, share content with potential and current customers, and access automated analytics and recommendations to improve sales performance. Meetings analyzed by the platform 100 can include sales meetings, in which a member of a sales team communicates with customers or potential customers to, for example, pitch products or services or to answer questions. However, the platform 100 can be used for similar purposes outside of sales enablement, including for workplace environments other than sales and for formal or informal educational environments.

Furthermore, although the meeting repository 110, meeting analyzer 120, and visualization generator 130 are illustrated as being components of the content management platform 100, these systems can operate independently of a platform in other implementations.

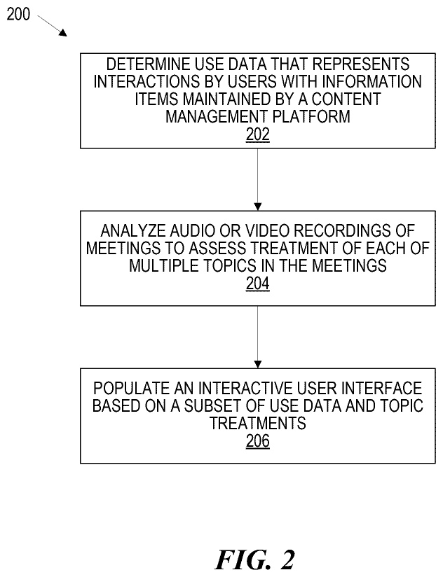

FIG. 2 is a flowchart illustrating a process 200 for evaluating treatment of specified topics in meetings and measuring corresponding impacts of the treatment, according to some implementations. The process 200 can be performed by the content management platform 100. Other implementations of the process 200 include additional, fewer, or different steps, or perform the steps in different orders.

At 202, the content management platform 100 analyzes meeting recording files to assess the meetings' treatment of one or more topics. The meeting recording files are digital files that each contain records of at least a portion of a meeting between two or more users of the platform 100. For example, meetings can be held in various digital formats, such as videoconferences, audio conferences, or telephone calls, which are conducted through the platform or via an external communication platform. Similarly, some of the meeting recording files can include recordings of in-person meetings. A meeting recording file of one of these meetings can include, for example, an audio recording of the meeting, a video recording that captures any video shared between meeting participants (e.g., video of the participating users and/or a video that captures screen sharing between participants), or a transcript of the meeting's audio. Using the LLM 140 and/or vector searches, the content management platform 100 identifies when a topic is addressed in a meeting. A topic can be, for example, a particular slide or content item to be shared, a concept to be discussed, a word or phrase to be used, or a product to be demonstrated. The content management platform 100 can also generate a topic assessment metric, which scores or grades the treatment of the topic. In various examples, the topic assessment metric can assess a certainty that the topic was addressed in a meeting or how well the topic was addressed. Analysis of audio or video recordings and assignment of topic assessment metrics is described further with respect to FIGS. 4-7.

In some implementations, the topics that are evaluated by the platform 100 include a predefined set of topics. This set of topics can include, for example, topics that are associated with a specific initiative in an organization. For example, a marketing or sales specialist can input a list of topics that a sales or marketing team should address in pitches to potential customers as part of a particular ongoing promotion or to achieve certain sales or engagement goals. Each user-specified topic can include a name, title, or identifier of the topic and a short description of the topic. Alternatively, the content management platform 100 can automatically determine at least some of the topics based on performance goals and observations of past performance tied to certain topics. For example, if an organization's goal is to increase sales of a particular product, the content management platform 100 can identify a content item that, when shared with potential purchasers of the product, is correlated with increased sales.

At 204, the content management platform 100 determines use data that represents user interactions with information items maintained by the platform. As described above, the content management platform 100 can capture use data that quantifies how users interact with content items in the content repository, such as viewing the content items, editing the content items, or sharing the content items. The platform 100 can additionally or alternatively track other interactions with the platform itself, with systems or websites related to the platform, or with other users of the platform. For example, the platform 100 can access data that describes whether a user has accessed a link in an email, an email recipient has or has not responded to the email, a user has or has not returned a telephone call to another user of the platform, or a user has made a purchase from an organization affiliated with the platform. The use data retrieved by the content management platform 100 can relate to user interactions with specific content or information that is determined to be related to meetings in which the corresponding users have participated.

At 206, the content management platform 100 generates an interactive user interface that correlates use data against treatment of topics across a set of meetings. The interactive user interface can be presented in the form of a scorecard that displays information about the assessment of the meetings' treatment of each of the obtained topics. The topic treatment data can be stored with data indicating the user who presented the topic, the time of the presentation of the topic, and/or the audience of the topic's presentation. Using this stored data, the content management platform 100 can generate aggregated representations of the data at different times and for different users that can be correlated against an organization's goals or outcomes.

The interactive user interface can display information that correlates any desired set of topic assessment metrics to corresponding use data. To generate the interactive user interface, the content management platform 100 can select subsets of use data and topic assessment metrics. These subsets can be selected based in part on user inputs. A user input can specify, for example, a time period to be populated into the user interface. In an example, a manager within an organization may be interested in understanding the topics that have been discussed in meetings held by members of the manager's team within the last month. The platform 100 then selects a subset of meeting recording files for meetings that occurred within the specified time period. The topic assessment metrics for these meeting recording files can be correlated against any use data from during or after the specified time period. For example, the platform 100 retrieves use data associated with external customers who attended the meetings held by the manager's team, which, for example, can describe whether the customers interacted with certain content or whether the customers purchased a product or service after the meetings.

Alternatively, a user input can specify a first set of users within an organization. For example, the manager of the team can select specific team members. The platform 100 can then identify any meetings held or attended by the users in the first set of users. The topic assessment data associated with these meetings can be populated into the user interface. Additionally, for each of these meetings, the platform 100 identifies a second set of users who also attended the meetings. Use data associated with the second set of users can also be populated into the user interface to correlate against the topic assessment data for the meetings.

In still another example, a user input can specify a set of topics. For example, if an organization has an ongoing sales initiative in which its salespeople are instructed to discuss a specified set of topics with potential customers, these topics can be selected for populating the user interface. In response, the platform 100 identifies any meetings that were determined to include a discussion of the specified topics. The topic assessment metrics applied to these meetings' treatments of the specified topics can be populated into the user interface. Use data associated with the attendees of these meetings can also be retrieved and populated into the interface to correlate against the topic assessment metrics.

In some implementations, correlated topic assessment metrics and use data can be plotted adjacent to each other or against one another. For example, a topic assessment metric that measures how well a salesperson presented a topic in a pitch meeting can be plotted against use that that indicates how potential customers responded to the pitches. The plot can show, for example, an x-axis that indicates whether the salesperson's presentation of the topic was “poor,” “good,” or “very good.” For each of these buckets, the plot can then show the number of attendees of each of the “poor,” “good,” or “very good” pitches who viewed a viewed a pitch deck for at least ten minutes after the pitch meeting.

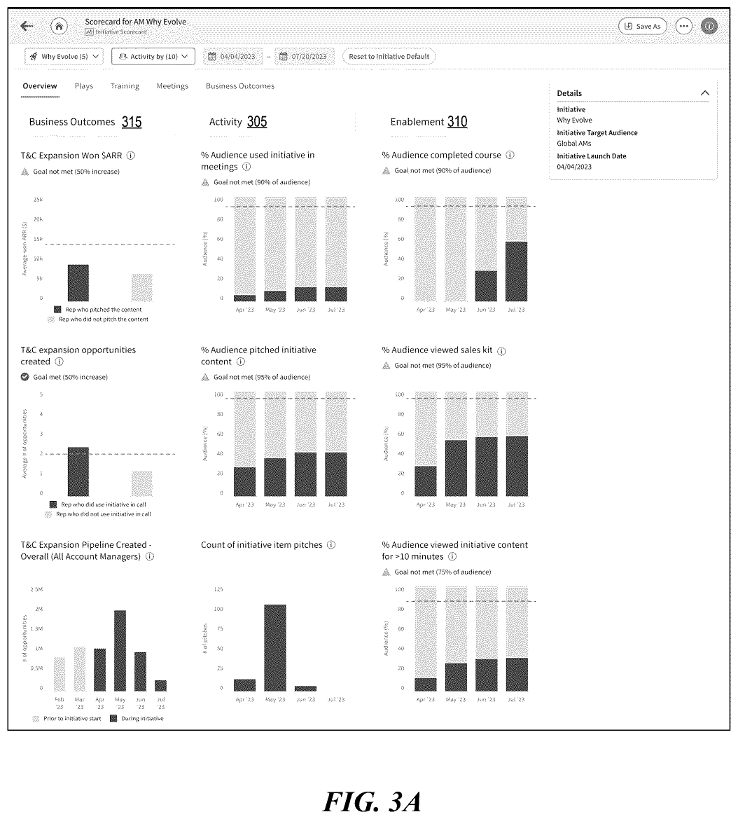

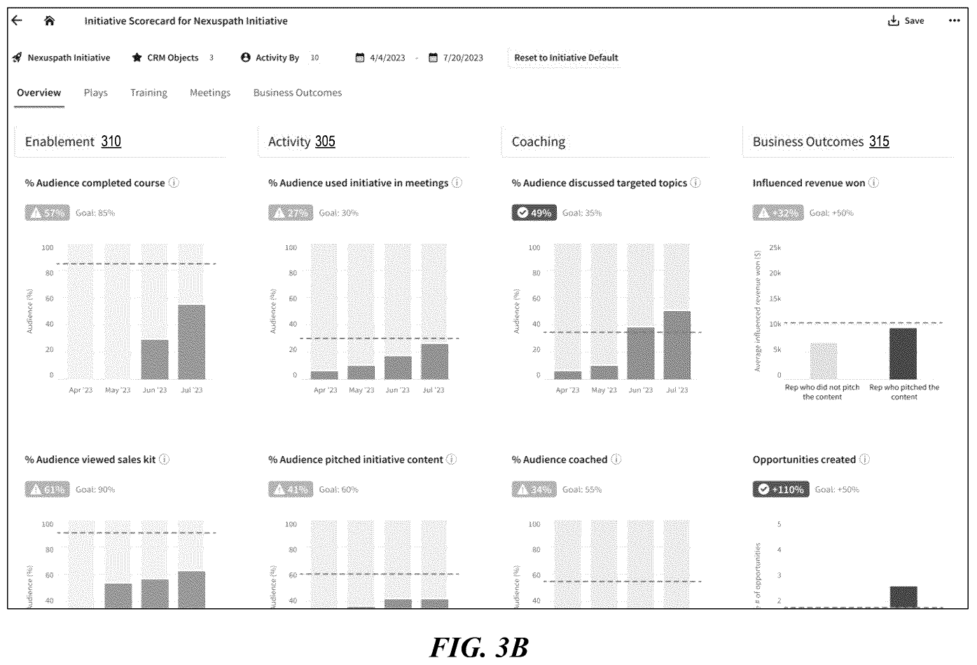

FIGS. 3A-3B illustrate example scorecards that can be generated by the platform 100 (e.g., using the visualization generator 130) and displayed via user devices 150, as example interactive user interfaces. The example scorecards illustrate meeting activity by salespeople within an organization and corresponding sales enablement targets associated with the attendees of these meetings. In FIGS. 3A-3B, for example, the scorecard illustrates several activity categories 305 and sales enablement categories 310. The activity categories 305 can represent actions by salespeople within the organization and include, in the illustrated example, a percentage of meetings in which the salespeople used the initiative in meetings, a percentage of meetings in which the salespeople pitched initiative content, and a count of initiative item pitches. The sales enablement categories 310 can represent activities performed by audiences outside the organization either during or after a meeting, and as illustrated can include a percentage of the audience that completed a course, a percentage of the audience that viewed a sales kit, and a percentage of the audience that viewed initiative content for more than ten minutes. For each category, the scorecard includes a bar chart representing a count or percentage of meetings in which the activity was or was not performed or a count or percentage of follow-up actions performed by meeting attendees after the meetings. Each category has a respective goal that is also displayed on the scorecard.

The count or percentage for each category that is displayed on the scorecard can be obtained based on aggregated meeting data associated with specified users or sets of users and within specified periods of time. For example, the scorecard illustrated in FIG. 3A includes meeting data aggregated from ten users within an organization over each of four months, thus representing a total number of meetings within each of the four months in which the ten users and their audiences performed certain activities. However, the scorecard can be interactive to select different users or sets of users, different periods of time over which the meeting data is aggregated, or different initiatives. The scorecard can also be modified such that, instead of comparing an aggregate count of activities performed in different months, it displays a comparison between activities of individual users or groups of users, between types of audiences, between initiatives, or between other segments of data.

When generating the scorecard, the content management platform 100 can aggregate meeting data from any meeting in which a topic corresponding to the activity categories 305 was addressed. Alternatively, the platform can select meetings to include or exclude from the aggregated data set. For example, as described above, the content management platform 100 generates a topic assessment metric to represent the treatment of a topic during a meeting. Some topic assessment metrics may reflect the manner in which a user addressed the topic, such as whether the user addressed the topic in enough detail or for a sufficient length of time. Other metrics may represent a certainty that a particular topic was addressed, as opposed to, e.g., a different topic that employs similar vocabulary. Accordingly, the platform 100 may include only the meetings in the data set for the scorecard in which the treatment of a topic received a score that is above a specified threshold or below a specified threshold. The scorecard can include a control to select the topic assessment metrics that are to be displayed, in some cases. In other implementations, the scorecard aggregates meeting data according to the topic assessment metric assigned to each corresponding meeting. For example, in the bar chart generated for each activity 305, the content management platform 100 can display a stacked bar chart in which a count of meetings that addressed a topic and received a first score is displayed in a first color while a count of meetings that addressed the topic and received a second score is displayed in a second color within the stacked bar chart.

The scorecard can further display one or more business outcomes 315. The example scorecard in FIG. 3A illustrates business outcomes such as a number of expansion opportunities created and a number of expansion wins, while FIG. 3B further illustrates revenue as an example business outcome. The business outcomes 315 can be correlated against the activity categories 305 and sales enablement categories 310 to evaluate the effect of these categories on the desired goals of a business.

The scorecard provides a visual representation of the actions by users within or outside an organization, correlated to or evaluated against goals of the organization. In an example use case, a manager of a team of employees can use the scorecard to evaluate the employees' performance, including whether the employees are performing certain activities, how well they are performing these activities, and the results to the business when these activities are performed. In another example, a marketing director can use the scorecard to evaluate how well an initiative is working for the business. Rather than just evaluating whether business goals have been achieved, the marketing director can use the scorecard to determine if and how well the business' employees have been executing on the initiative. The marketing director can thus better determine, for example, if the initiative itself is the cause of the business achieving or not achieving its goal or if better training of the employees would improve the initiative's outcomes. In still another example use case, a school can use the scorecard to assess how well its teachers have taught certain material over the duration of a course and to correlate the teaching of this material to educational outcomes (e.g., test scores).

### II. Topic Identification and Assessment

As described above, the meeting analyzer 120 processes recordings of meetings to generate topic treatment data for input to the visualization generator 130. FIGS. 4-7 illustrate steps performed by the meeting analyzer 120 to identify the topics that arise during meetings and to evaluate the treatment of these topics in each meeting.

### A. Identifying Topics Discussed During Meetings

FIG. 4 is a flowchart illustrating a process 400 performed by the meeting analyzer 120 to identify topics discussed during meetings. Typically, the process 400 is used to identify topics in speech of the meeting participants, although similar steps can be used to identify topics that are raised in a meeting chat during a meeting or that are written or typed on a shared workspace during the meeting.

The meeting analyzer 120 ingests a recording of a meeting, 402. The meeting recording can be accessed from a repository of meeting recordings 110. For example, the meeting analyzer 120 processes meeting recordings upon detecting that a new recording has been added to the repository or on a batch basis (e.g., once per day). Alternatively, a user can upload the meeting recording to the meeting analyzer 120 or can explicitly select the meeting recording from the repository 110 for analysis by the system.

The meeting analyzer 120 applies a topic filter, 404, to the ingested meeting recording to identify a set of possible topics present in the meeting. In some implementations, the meeting analyzer 120 generates a set of vectors to represent respective portions of the meetings, such as words or phrases that are used, content that is shared, or meeting metadata (e.g., a meeting title, participant information, or a meeting agenda shared between participants in advance of the meeting). A measurement of similarity between the meeting vectors and vector representations of potential topics can be generated. Based on the similarity measurements, the meeting analyzer 120 identifies a set of candidate topics that may have been discussed during the meeting. For example, the meeting analyzer 120 selects the fifty topics with highest similarity scores to the portions of meetings. Alternatively, rather than performing a vector-based comparison to identify potential topics raised in meetings, the meeting analyzer 120 can send some or all of a meeting transcript to the LLM to cause the LLM to identify candidate topics.

At 406, the meeting analyzer 120 applies topic validation to validate which of the candidate topics, if any, were addressed during the meeting. Topic validation can employ the LLM 140. In at least some implementations, the meeting analyzer 120 generates one or more snippets of a meeting, where each snippet represents a portion of the meeting that possibly contains one or more of the candidate topics. The generated snippets can be sent to the LLM 140 with the corresponding topic that was matched to each snippet. When sending the snippets and topics to the LLM, the meeting analyzer 120 can prompt the LLM 140 to determine if the snippet related to the corresponding topic. The output from the LLM 140 can be a binary assessment indicating either that the snippet did or did not relate to the corresponding topic, or an assessment of a degree of likelihood that the snippet did or did not relate to the corresponding topic.

The snippet can be generated by determining a portion of content within a meeting in which the candidate topic was likely being discussed, for example based on the portion of the meeting for which a vector match to a candidate topic was found. The meeting analyzer 120 may additionally include in the snippet a certain amount of content before and after the portion of the meeting that likely contains the candidate topic. Alternatively, once a vector match to a candidate topic has been found, the meeting analyzer 120 can perform a search of the meeting transcript for particular keywords that are likely to relate to the candidate topic, use natural language processing techniques to identify words or phrases that are likely to relate to the candidate topic, or perform other classical analyses of the meeting transcripts to identify the portions that should be included in each snippet.

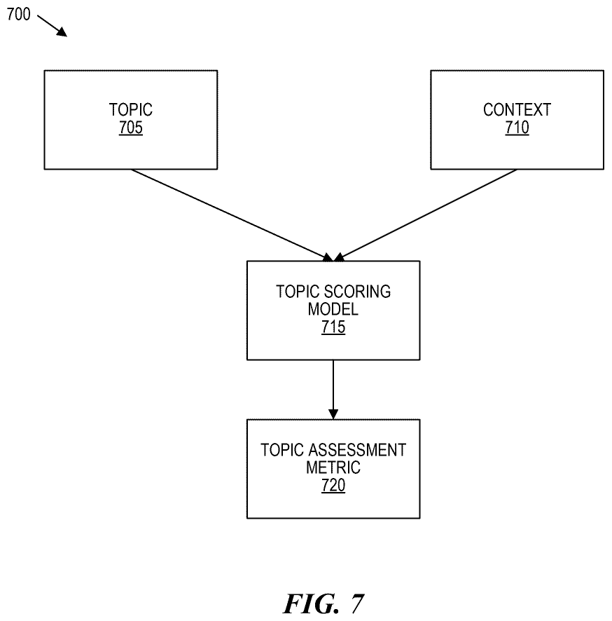

At 408, after receiving a validation that a topic was discussed in a particular snippet of the meeting, the meeting analyzer 120 grades the treatment of the topic within the snippet. The grade can include a qualitative or quantitative assessment of the meeting based on its treatment of the topic. For example, the snippet can be rated as one of a “good” treatment of the topic, a “better” treatment of the topic, or a “best” treatment of the topic. Grades can additionally or alternatively reflect the length of time each topic was addressed, thus labeling the meeting as a “brief” treatment of the topic, a “medium” treatment, or an “extensive” treatment. Furthermore, grades can evaluate the treatment of the topic for different purposes, such as by assigning scores based on the treatment's suitability for different audiences or by different presenters. Topic grading is described further with respect to FIG. 7.

### B. Identifying Topics Based on Content Shared During Meetings

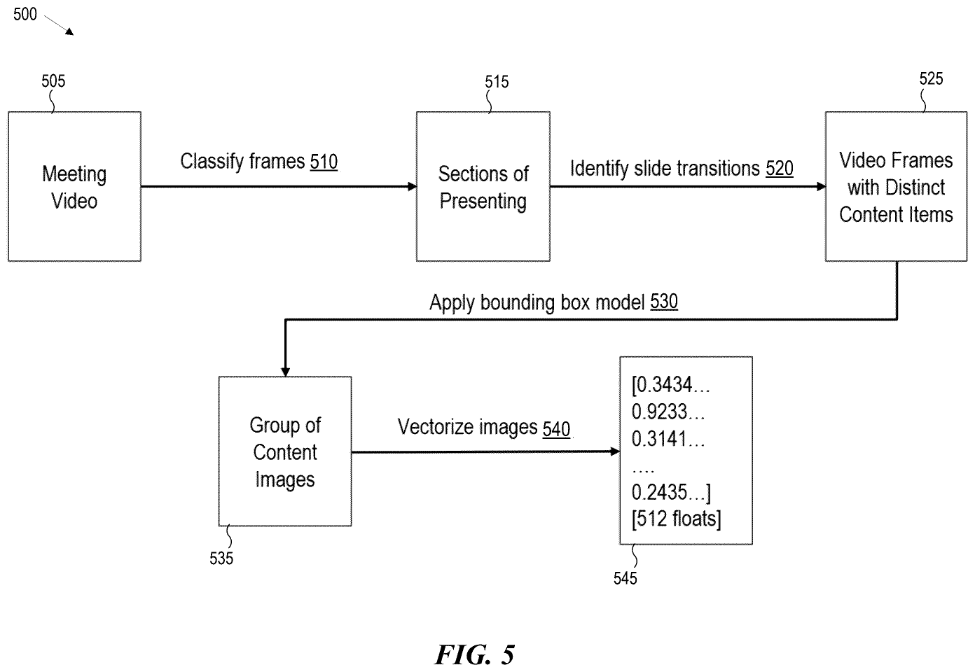

The topics identified by the meeting analyzer 120 can also include specific content items that are presented in a meeting. FIG. 5 is a flowchart illustrating a process performed by the meeting analyzer 120 to identify content that is shared during meetings, according to some implementations. Some implementations of a content identification method are described in U.S. patent application Ser. No. 18/917,779, filed Oct. 16, 2024, which is incorporated herein by reference in its entirety.

As shown in FIG. 5, the meeting analyzer 120 receives a video recording 505 of a videoconference meeting. At 510, the meeting analyzer 120 applies a classifier to classify frames from the meeting recording 505. The frame classifier, according to at least some implementations, is a deep learning model that is trained with labeled images to classify video frames into one of multiple candidate classifications. In an example, the frame classifier is trained to classify video frames as either (i) a non-sharing frame (e.g., when only participants' videos are displayed, with no content sharing), (ii) a general-content frame (e.g., when a screen is being shared, but the screen does not contain a specific content item (such as if the screen being shared is a presenter's desktop, a blank document, or a webpage)), or (iii) a specific-content frame. The frame classifier can be trained by supervised learning techniques in which training data includes frames from videoconference recordings that are assigned a certain category label. A representation of a frame from a videoconference recording can be provided to the model. Output from the model can be compared to the desired classification for that frame and, based on the comparison, the model can be modified, such as by changing weights between nodes of the neural network or parameters of the functions used at each node in the neural network (e.g., applying a loss function). After applying each of the labeled frames in the training data and modifying the model in this manner, the model can be trained to evaluate new videoconference frames to assign a corresponding classification to each frame.

Some implementations of the frame classifier can further use signals other than an image within the video frame to assign classifications, such as metadata associated with the videoconference, a transcript for the conference, or previous frame classifications. For example, a videoconferencing platform may add indicators within a transcript of a meeting or in metadata associated with the recording to indicate when screen sharing began or ended. In another example, the frame classifier processes text of the transcript to identify verbal cues that may suggest a user is sharing content or is not sharing content, such as “Let me share my screen,” “Can everyone see my screen?,” “next slide,” or the like.

The meeting analyzer 120 can process a subset of the frames in the meeting recording 505 using the frame classifier. Because the same content item may be displayed on a presenter's screen for several seconds to several minutes, the meeting analyzer 120 can increase the speed and efficiency of video processing by not applying the frame classifier to every frame in the video. For example, the meeting analyzer 120 applies the frame classifier to a frame sampled from the video at periodic intervals, such as every 3-5 seconds. If the classification changes from a first sampled frame to a second, consecutively sampled frame, the meeting analyzer 120 can perform a binary search of the frames between the first frame and the second to determine the frame at which the classification changed. Alternatively, the meeting analyzer 120 can process a transcript or video metadata to detect a likely change in classification, for example to identify a signal indicating that a user likely started or stopped sharing content.

As an output of the frame classification process, the meeting analyzer 120 can identify any sections 515 within the meeting recording in which content items are being shared. For example, the meeting analyzer 120 outputs a list of timestamps or frame identifiers indicating when sharing of a specific content item started and ended throughout the duration of the meeting recording. The frames of the meeting recording that were not directly classified by the frame classifier can be assigned a classification based on the portion of the video in which they fall. For example, if Time A is recorded as the point when specific content sharing began and Time B recorded as the end of specific content sharing, each slide between Time A and Time B can be classified as a specific-content frame. In various implementations, and depending on the type of content that the content management platform 100 is seeking to identify in a videoconference, the set of sections 515 output by the meeting analyzer 120 can represent the portions of the videoconference classified as specific-content frames, general-content frames, or both.

At 520, the portions of the meeting recording that were determined to contain specific-content sharing (e.g., all video frames classified as a specific-content frame) are passed to a slide transition identification procedure. In the slide transition identification procedure, the meeting analyzer 120 identifies time stamps or frame identifiers at which transitions between content items occurred. For example, if the content being shared during a videoconference is a slide deck, the slide transition identification procedure determines when the presenter transitioned from one slide within the slide deck to the next. Similarly, the slide transition identification procedure can determine when a presenter moves to a next page in a document, switches from one content item (e.g., a first document) to another content item (e.g., a second document), or otherwise changes the content that is being shared during the videoconference. To detect these transitions, the meeting analyzer 120 can perform an analysis of pixels in the frames classified as specific-content frames. Frames can be pre-processed to remove pixels that are unlikely to include the shared content, such as an outer portion of the frame and any portion of the frame in which participant videos are displayed. Using the pre-processed frames, the meeting analyzer 120 can perform a frame-by-frame comparison of the pixels in each frame to detect when the shared content changes. For example, if at least 5% of the pixels in a pre-processed frame change from one frame of the meeting recording to the next, the meeting analyzer 120 determines that the content has changed. Additionally or alternatively, the meeting analyzer 120 can process verbal signals in the videoconference's transcript to detect signifiers that the content has changed or will change soon.

The output of the slide transition identification procedure 520 can be a set of video frames 525 that contain distinct content.

In some implementations, the meeting analyzer 120 selects at least a subset of the general-content frames at 520, in addition to or instead of identifying transitions between content items within the frames labeled as specific-content frames. For example, the meeting analyzer 120 captures a subset of the general-content frames from a videoconference. A subset of general-content frames can be sampled rather than identifying transitions between distinct content items within these frames, as described above for the specific-content frames. For example, a general-content frame may be more likely to include a video, a demonstration of a product, or another type of content presentation in which the pixels of the frames vary significantly from one frame to the next.

At 530, the meeting analyzer 120 applies a bounding box model to the identified set of video frames 525. The bounding box model can take an array of pixels as input and produce, as output, four floating-point numbers that represent corners of a box. The bounding box model can be a convolutional neural network model that is trained to classify pixels in a video frame as “content” or “not content,” for example. As a result, the bounding box model can define a portion of each video frame in the set 525 that contains the shared content, cutting out pixels such as those containing thumbnails of the videoconference participants, window frames of the video itself or of the application in which content is being shared, or other portions of the video frame that are likely to be not specific to the shared content. The output of the bounding box application procedure 530 can be a group of content images 535, where each content image is a portion of a video frame. In some implementations, the meeting analyzer 120 can further output an identification of an amount of time each content image was displayed during the videoconference, based on the number of frames of the video in which the content image appeared.

At 540, the meeting analyzer 120 performs a vectorization process on each image in the set of content images 535 to produce a vector 545 uniquely representative of the content image. The meeting analyzer 120 can employ any of a variety of vectorization algorithms, such as img2vec, to produce a vector representation of each content image. In some implementations, the meeting analyzer 120 filters the group of content images 535 prior to applying the vectorization algorithm. For example, the meeting analyzer 120 removes any content image that was displayed within the recorded video for less than one second, based on a determination that the content was likely to have been displayed only incidentally (e.g., because the presenter skipped past a slide in a slide deck) or that the content likely included moving elements (e.g., in case a video or animation was shared during the videoconference).

Accordingly, by the end of the video processing flow 500, the meeting analyzer 120 has produced a set of vectors that represent images of content items or portions of content items shared during a videoconference. The vectors can further be associated with information indicating the amount of time the corresponding content item was displayed during the videoconference, such as time stamps of the start and end points for a content item being shared.

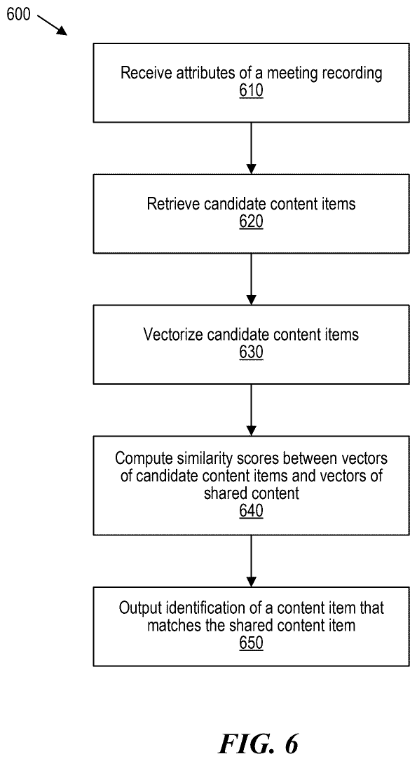

The vectors generated by the video processing flow 500 can be matched to content items in a content repository to identify the items shared during a videoconference. FIG. 6 is a flowchart illustrating a process 600 for matching the content pages identified in a videoconference to specific content items in a content repository.

As shown in FIG. 6, the meeting analyzer 120 receives, at 610, attributes of a meeting recording to which the meeting analyzer 120 will match content. The attributes can include any metadata associated with the recording or knowledge graph data that can be used to help identify content shared during the meeting or to speed up a process of finding the shared content. For example, these attributes can include an identifier of a user who presented content during the videoconference and a date of the videoconference. Other example attributes received by the meeting analyzer 120 can include a list of meeting attendees, a title of the meeting, or subjects discussed during the meeting, which can be used to identify a likely subject matter of any content that was shared during the meeting.

At 620, the meeting analyzer 120 retrieves candidate content items from the content repository. Candidate content items can be selected based on a heuristic. For example, the meeting analyzer 120 retrieves any content item that was accessed by the presenting user in the last 30 days, based on an expectation that the presenter likely created, edited, or reviewed the content item that was presented during the meeting in advance of the meeting. Alternatively, the meeting analyzer 120 can retrieve a set of content items that the presenting user frequently shares during videoconferences or has historically shared during videoconferences with the same attendees as the conference under evaluation. The meeting analyzer 120 may also retrieve only certain types of content items based on an expectation that some types of content are more likely to be shared in a videoconference than other types of content items. For example, the meeting analyzer 120 may begin a content matching procedure by first retrieving only slide decks, only expanding a search to other types of content if no matching slide deck is found. In implementations where the content management platform 100 maintains private data for organizations or data to which access is controlled by access rights, the content items that are retrieved at step 620 can be content items to which the presenting user has appropriate permissions or access rights.

Some implementations of the meeting analyzer 120 can be configured to determine whether a user has shared a particular content item (or a content item from a particular set) during videoconferences, instead of or in addition to generally identifying any content item shared during a conference. Accordingly, the set of candidate content items can include the particular content item or set of particular content items. For example, if a company is evaluating whether its salespeople are presenting a certain slide during sales pitches, the slide can be included in the set of candidate content items matched to content extracted from recordings of the sales pitches.

After identifying candidate content items, the meeting analyzer 120 vectorizes the candidate content items at 630. The meeting analyzer 120 can generate vectors to represent the candidate content items using the same vectorization algorithm as that used by the meeting analyzer 120 to generate the vectors 545. For content items with multiple pages, such as a slide deck, the meeting analyzer 120 can generate a vector for each page within the content.

For at least a subset of the vectors representing a shared content page, the meeting analyzer 120 at 640 determines a similarity, such as a cosine similarity, between the shared content vector and a vector representing a candidate content item. Based on the similarity score, the meeting analyzer 120 determines whether the shared content page matches one of the candidate content items. A match to a shared content item can be determined, for example, when a highest similarity score between the shared content item and a candidate content item is greater than a specified threshold. When a match is found between a shared content item and a candidate content item, the meeting analyzer 120 can narrow the set of candidate content items that are compared to other shared content items from the same videoconference. For example, if the meeting analyzer 120 finds a match to a first slide in a slide deck, the meeting analyzer 120 can start by comparing the next content item extracted from the videoconference to other slides in the same slide deck before searching for a match among other candidate content items.

If a match is found, the meeting analyzer 120 outputs an identifier of the match at 650. If no match is found to a shared content page, the meeting analyzer 120 can either expand the set of candidate content items and repeat the matching process 600, or can output a determination that no match is available.

In some implementations, each content item in the content repository is vectorized prior to the matching process 600. Accordingly, rather than selecting candidate content items or to more quickly search the candidate content items, the meeting analyzer 120 can perform a vector search of a vector database associated with the content repository to identify content items in the content repository that are similar to the vector produced for the content item extracted from the videoconference.

Instead of or in addition to processing specific-content frames as described with respect to FIG. 6, some implementations of the meeting analyzer 120 can process general-content frames to identify the content that is shared on the general-content frames. For some types of content, the meeting analyzer 120 can extract text from the video recording frames to identify the content of a general-content frame. In an example, the meeting analyzer 120 extracts a URL from a browser window displayed during the video. For other types of content, the meeting analyzer 120 can perform similar analysis as is performed for specific-content frames. For example, a product demo can have an associated vector representing features of the product demo (e.g., representing visual elements that are likely to be displayed during the demo or words that the presenter is likely to speak during the demo). The general-content frames can be vectorized by a similar vectorization algorithm. The meeting analyzer 120 can then determine a similarity between the vector of the general-content frames and the expected product demo vectors to determine whether it is likely that the general-content vectors include the product demo. Alternatively, the meeting analyzer 120 can send a transcript of the presenter's speech coinciding with the general-content frames to a large language model, which in turn can analyze latent space embeddings of the speech to determine if the presenter was speaking about a particular topic (e.g., demoing a particular product).

### C. Scoring Topic Treatment

Once topics in a meeting have been identified, the meeting analyzer 120 generates topic assessment metrics that evaluate the treatment of the topics in the meeting. FIG. 7 is a data flow diagram illustrating a process 700 performed by the meeting analyzer 120 to generate topic assessment metrics, according to some implementations.

As shown in FIG. 7, a topic 705 and context 710 from the meeting are input to a topic scoring model 715, The topic 705 can be the topic that has been matched to a portion of a meeting recording file, such as by any of the processes described with respect to FIGS. 4-6. The context 710 can include the snippet of the meeting during which the topic was discussed. Optionally, the context can include other data from or associated with the meeting, such as an identity of a presenter in the meeting, an identity of any other meeting attendees, location of the meeting attendees, or an overall subject matter of the meeting. The topic scoring model 715 can include any of a variety of rule-based or machine learning-based models that are configured to input at least a portion of a meeting recording file, and to generate a topic assessment metric 720 for the meeting recording file that qualifies or quantifies the treatment of a given topic during the corresponding meeting.

In some implementations, the topic scoring model 715 includes the LLM 140. The meeting analyzer 120 inputs the topic 705 and context 710 to the LLM 140, with a prompt to generate a grade for the meeting based on the topic and the context.

To generate a topic assessment metric, the LLM 140 can be provided examples of meeting contexts that are labeled with possible topic assessment metrics. Example meetings can be labeled by a user in some cases. For example, a manager within an organization can label a set of example meeting snippets based on whether the manager assessed the meeting snippet to be a “good” treatment of a topic or a “best” treatment of a topic. Meeting snippets can instead be labeled by peer reviewers (e.g., other employees within an organization) or audience members (e.g., potential customers of an organization who attend sales pitches by employees of the organization). In other cases, example meetings are labeled automatically by the meeting analyzer 120. Meeting snippets and their context can be scored, for example, based on an outcome of the meeting, such as whether a customer made a purchase related to the topic after the meeting, whether a meeting attendee viewed a topic-related content item and how long they viewed the item after the meeting, or whether a meeting attendee responded to a follow-up communication about the topic. In still other implementations, the meeting analyzer 120 provides the LLM 140 with a rubric that identifies criteria for scoring a meeting's treatment of a topic, instead of or in addition to providing labeled samples.

The labelled meeting examples or criteria for scoring a meeting's treatment can cause the LLM 140 to apply any of a variety of different qualitative or quantitative assessments to the topic 705 that evaluate a quality of a discussion of the topic during a meeting snippet. The LLM 140 can be provided with labeled examples of “good,” “better,” and “best” treatment of a topic, in one example. In another example, the labeled examples are rated with numerical or letter scores, such as scores from 1-5 or letter grades of A-F. The topic assessment metrics assigned to each meeting may reflect the substance of the discussion of the topic in the meeting, such as whether a presenter used the correct vocabulary to describe the topic or whether the presenter discussed all facets of a topic. The metric can further or alternatively reflect the length of the discussion of the topic within the meeting. The meeting analyzer 120 can also evaluate non-substantive elements of the meeting when evaluating the meeting's treatment of a topic, considering, for example, the number of filler words used by the presenter, the formality or informality of the presenter's speech, the volume or pace of the presenter's speech, or whether the presenter was interrupted regularly by other attendees of the meeting.

In some cases, the topic assessment metric assigned by the LLM 140 reflects a certainty by the LLM that a particular topic is being discussed in a meeting. Some topics may use vocabulary that is similar to other topics, for example, or a user may address a topic either too briefly in a meeting or with too many interruptions for the LLM 140 to determine with confidence that the topic was addressed. In some cases, the LLM 140 can be provided with other example meeting snippets in which other similar topics were discussed, helping the LLM distinguish between a target topic and these similar topics. Alternatively, the LLM 140 can be provided with a description of other similar topics or a list of key words or phrases that may help the LLM distinguish between closely related topics.

Instead of or in addition to using the LLM 140, some implementations of the meeting analyzer 120 use rule-based models to determine topic assessment metrics for meetings. For example, a meeting recording file can be assigned a binary score that indicates whether a topic was addressed during the corresponding meeting. In another example, the topic assessment metric is generated based on an amount of time that a topic is discussed during a meeting, where, for example, a longer discussion of the topic leads to a higher score than a shorter discussion of the topic. A rule-based model can also generate topic assessment metrics based on a combination of multiple factors. For example, the meeting analyzer 120 can compute a topic assessment metric based on the length of time the topic was addressed during a meeting, the number of meeting attendees who participated in the discussion of the topic, and whether certain keywords appeared in the discussion of the topic.

### III. Large Language Models

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

Many machine learning techniques are based on neural networks. A neural network model has three major components: architecture, cost function, and search algorithm. The architecture defines the functional form relating the inputs to the outputs (in terms of network topology, unit connectivity, and activation functions). During a training process, a computing system performs a search in weight space for a set of weights that minimizes the objective function.

A neural network has a set of input nodes that receive input data. The input nodes can correspond to functions that receive the input and produce results. These results can be provided to one or more levels of intermediate nodes (“hidden layers”) that each produce further results based on a combination of input node results. A weighting factor is applied to the output of each input node before the result is passed to the hidden layer nodes. The hidden layer can have lower dimensionality than the input and/or output layers, in some implementations. At a final layer (“the output layer”), a set of output nodes are mapped to output data. Once the neural network is trained, application of the field values to the input and output nodes produces a latent vector at the hidden layer that represents features of the input data.

Some neural networks, known as deep neural networks, have multiple layers of intermediate nodes with different configurations, are a combination of models that receive different parts of the input and/or input from other parts of the deep neural network, or are convolutions-partially using output from previous iterations of applying the model as further input to produce results for the current input.

A large language model uses a neural network, usually a deep neural network, to perform natural language processing (NLP) tasks. A language model may contain hundreds of thousands of learned parameters, and large language models in particular may contain millions or billions of learned parameters.

Some LLMs are implemented using transformers, which are a type of neural network architecture that uses self-attention mechanisms in order to generate predicted output based on input data that has some sequential meaning. Although example functions of a transformer are described herein, a person of skill in the art will recognize that other language models can be used, including language models based on other neural network architectures such as recurrent neural network (RNN)-based language models.

A transformer includes an encoder (which may comprise one or more encoder layers/blocks connected in series) and a decoder (which may comprise one or more decoder layers/blocks connected in series). The encoder and decoder can each include a plurality of neural network layers, at least one of which may be a self-attention layer. The parameters of the encoder and decoder's neural network layers may be referred to as the parameters of the language model.

The transformer is trained on a text corpus, which can be labeled (e.g., annotated to indicate verbs, nouns, etc.) or unlabeled.

To process textual input data using the transformer, a natural language string is tokenized into integers that correspond to the index of a text segment (e.g., a word, a punctuation mark, formatting information, classification information, etc.) in a vocabulary dataset. A length of the natural language string that can be processed by the transformer may be limited by the dimensions of the transformer.

An embedding is then generated for each of the tokens from the string. An embedding, also referred to as an embedding vector, is a numerical representation of a token that captures some semantic meaning of the text segment represented by the token. An embedding represents the text segment corresponding to the token in a way such that embeddings corresponding to semantically-related text are closer to each other in a vector space than embeddings corresponding to semantically-unrelated text. To generate the embedding, a system can apply the token to a trained neural network that generates an embedding based on a vector in a latent space of the neural network. In other implementations, the numerical value of the token can be used to look up the corresponding embedding in an embedding matrix, which may be learned during training of the transformer.

The embeddings are input at the first layer of the encoder. The encoder encodes the embeddings into feature vectors that represent the latent features of the embeddings. The encoder can encode positional information of the tokens (i.e., information about the sequence of the input) in the feature vectors. The feature vectors may have very high dimensionality (e.g., on the order of thousands or tens of thousands), with each element in a feature vector corresponding to a respective feature. Each element in the feature vector has a numerical weight that represents the importance of the corresponding feature. The space of all possible feature vectors that can be generated by the encoder may be referred to as the latent space or feature space.

The decoder maps the features represented by the feature vectors into meaningful output, which may depend on the task that was assigned to the transformer. For example, if the transformer is used for a translation task, the decoder maps the feature vectors into text output in a target language different from the language of the original tokens. Generally, in a generative language model, the decoder serves to decode the feature vectors into a sequence of tokens. The decoder may generate output tokens one by one. Each output token can be fed back as input to the decoder in order to generate the next output token. By feeding back the generated output and applying self-attention, the decoder generates a sequence of output tokens that has sequential meaning (e.g., the resulting output text sequence is understandable as a sentence and obeys grammatical rules). The resulting sequence of output tokens is then converted to a text sequence in post-processing. For example, like the input tokens, each output token is an integer number that corresponds to a vocabulary index. By looking up the text segment using the vocabulary index, the text segment corresponding to each output token can be retrieved. The resulting text segments can be concatenated and the final output text sequence can be obtained.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

### IV. Computer System

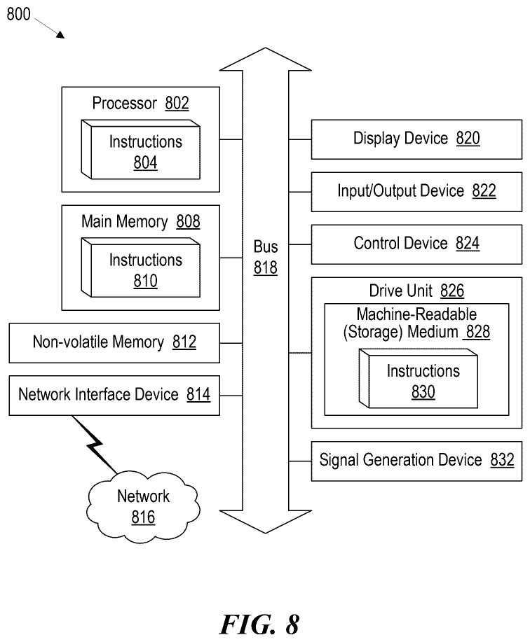

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real-time, near real-time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### V. Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A method comprising:
generating an interactive user interface that correlates (i) user interaction data associated with content items maintained by a content management platform, against (ii) treatment of topics, from a set of topics, in multiple meeting recording files stored by the content management platform;
wherein each of the meeting recording files is a digital file that contains a record of at least a portion of a digital meeting between two or more users of the content management platform;
determining use data that represents interactions by users of the content management platform with information items maintained by the content management platform;
assigning, by the content management platform, a topic assessment metric to each of a plurality of meeting recording files, wherein the topic assessment metric describes treatment of each of multiple topics in the plurality of meeting recording files, and wherein assigning the topic assessment metric includes, for a respective meeting recording file:
generating a vector representation of a portion of the respective meeting recording file;
matching the portion of the respective meeting recording file to a candidate topic based on a similarity metric between the vector representation of the portion and a vector representation of the candidate topic;
applying a scoring model to the portion of the respective meeting recording file, the scoring model when applied configured to output the topic assessment metric for the treatment of the candidate topic for the portion of the meeting recording file;
selecting a subset of the use data and the plurality of meeting recording files; and
populating the interactive user interface based on the selected subset of the use data and one or more topic assessment metrics associated with the plurality of meeting recording files.

2. The method of claim 1, wherein assigning the topic assessment metric further includes:
generating a snippet of a first meeting recording file that includes at least the portion of the first meeting recording file;
wherein the snippet is matched to a first candidate topic based on a similarity metric between a vector representation associated with the snippet and a vector representation of the first candidate topic; and
sending the snippet and the first candidate topic to a large language model (LLM) to validate whether the snippet includes a discussion of the first candidate topic by participants in a meeting associated with the first meeting recording file.

3. The method of claim 2, wherein applying the score model to the portion of the meeting recording file comprises:
prompting the LLM to assess a quality of a discussion of the first topic within the snippet;
wherein the topic assessment metric is determined based on the assessed quality.

4. The method of claim 1, wherein a second topic of the multiple topics is a specified content item that is presented within a shared screen during a meeting associated with a second meeting recording file, wherein the second meeting recording file includes a plurality of frames of a video recording of the associated meeting, and wherein assigning the topic assessment metric further includes:
accessing a set of frames of the second meeting recording file;
generating, for each respective frame in the set of frames, a vector representation of an image of at least a portion of the respective frame; and
matching an image of a respective frame in the set of frames to a selected content item from a content repository, based on a degree of similarity between (i) the vector representation of the image of the respective frame in the set of frames, and (ii) a vector representation of the selected content item.

5. The method of claim 1, further comprising:
receiving a user input that specifies a time period for populating the interactive user interface; and
in response to the user input:
selecting the subset of the plurality of meeting recording files by identifying meetings that occurred within the specified time period; and
selecting the subset of the use data from a set of use data that occurred after the specified time period.

6. The method of claim 1, wherein the content management platform maintains meeting recording files associated with an organization, and wherein the method further comprises:
receiving a user input that specifies a first set of users within the organization;
wherein the subset of the plurality of meeting recording files correspond to a set of meetings attended by users in the first set of users; and
wherein selecting the subset of the use data comprises:
identifying a second set of users who attended the identified meetings; and
retrieving use data that represents interactions by users in the second set of users with information items maintained by the content management platform.

7. The method of claim 1, further comprising:
obtaining a set of topics;
wherein the topic assessment metric is assigned to each of the plurality of meeting recording files based on a treatment of each of the set of topics in the plurality of meeting recording files; and
receiving a user input that specifies a first topic from the set of topics;
wherein selecting the subset of the plurality of meeting recording files comprises identifying one or more meetings that included a discussion of the first topic; and
wherein selecting the subset of the use data comprises:
identifying a set of users who attended the identified meetings; and
retrieving use data that represents interactions by users in the set of users with information items maintained by the content management platform.

8. The method of claim 1, wherein assigning the topic assessment metric to each of the plurality of meeting recording files comprises:
accessing a batch of meeting recording files;
processing the meeting recording files in the batch to assign topic assessment metrics to each meeting recording file in the batch; and
storing the assigned topic assessment metrics in association with the meeting recording files in the batch.

9. The method of claim 1, wherein assigning the topic assessment metric to each of the plurality of meeting recording files comprises:
detecting a new meeting recording file has been added to the content management platform;
processing the new meeting recording file to assign one or more topic assessment metrics to the new meeting recording file; and
storing the one or more topic assessment metrics in association with the new meeting recording file.

10. The method of claim 1, wherein a meeting recording file of the multiple meeting recording files includes an audio file, a video file, or a transcript.

11. A content management system comprising:
one or more processors; and
one or more non-transitory computer readable media storing executable computer program instructions that, when executed by the one or more processors, cause the content management system to:
generate an interactive user interface that correlates (i) user interaction data associated with content items maintained by a content management platform, against (ii) treatment of topics, from a set of topics, in multiple meeting recording files stored by the content management platform;
wherein each of the meeting recording files is a digital file that contains a record of at least a portion of a digital meeting between two or more users of the content management platform;
determine use data that represents interactions by users of the content management platform with information items maintained by the content management platform;
assign a topic assessment metric to each of a plurality of meeting recording files, wherein the topic assessment metric describes treatment of each of multiple topics in the plurality of meeting recording files, and wherein assigning the topic assessment metric includes, for a respective meeting recording file:
generating a vector representation of a portion of the respective meeting recording file;
matching the portion of the respective meeting recording file to a candidate topic based on a similarity metric between the vector representation of the portion and a vector representation of the candidate topic;
applying a scoring model to the portion of the respective meeting recording file, the scoring model when applied configured to output the topic assessment metric for the treatment of the candidate topic for the portion of the meeting recording file;
select a subset of the use data and the plurality of meeting recording files; and
populate the interactive user interface based on the selected subset of the use data and one or more topic assessment metrics associated with the plurality of meeting recording files.

12. The content management system of claim 11, wherein assigning the topic assessment metric further includes:
generating a snippet of a first meeting recording file that includes at least the portion of the first meeting recording file;
wherein the snippet is matched to a first candidate topic based on a similarity metric between a vector representation associated with the snippet and a vector representation of the first candidate topic; and
sending the snippet and the first candidate topic to a large language model (LLM) to validate whether the snippet includes a discussion of the first candidate topic by participants in a meeting associated with the first meeting recording file.

13. The content management system of claim 11, wherein a second topic of the multiple topics is a specified content item that is presented within a shared screen during a meeting associated with a second meeting recording file, wherein the second meeting recording file includes a plurality of frames of a video recording of the associated meeting, and wherein assigning the topic assessment metric further includes:
accessing a set of frames of the second meeting recording file;
generating, for each respective frame in the set of frames, a vector representation of an image of at least a portion of the respective frame; and
matching an image of a respective frame in the set of frames to a selected content item from a content repository, based on a degree of similarity between (i) the vector representation of the image of the respective frame in the set of frames, and (ii) a vector representation of the selected content item.

14. The content management system of claim 11, wherein assigning the topic assessment metric to each of the plurality of meeting recording files comprises:
accessing a batch of meeting recording files;
processing the meeting recording files in the batch to assign topic assessment metrics to each meeting recording file in the batch; and
storing the assigned topic assessment metrics in association with the meeting recording files in the batch.

15. The content management system of claim 11, wherein assigning the topic assessment metric to each of the plurality of meeting recording files comprises:
detecting a new meeting recording file has been added to the content management platform;
processing the new meeting recording file to assign one or more topic assessment metrics to the new meeting recording file; and
storing the one or more topic assessment metrics in association with the new meeting recording file.

16. The content management system of claim 11, wherein a meeting recording file of the multiple meeting recording files includes an audio file, a video file, or a transcript.

17. A non-transitory computer readable medium storing executable computer program instructions that, when executed by one or more processors of a system, cause the system to:
generate an interactive user interface that correlates (i) user interaction data associated with content items maintained by a content management platform, against (ii) treatment of topics, from a set of topics, in multiple meeting recording files stored by the content management platform;
wherein each of the meeting recording files is a digital file that contains a record of at least a portion of a digital meeting between two or more users of the content management platform;
determine use data that represents interactions by users of the content management platform with information items maintained by the content management platform;
assign a topic assessment metric to each of a plurality of meeting recording files, wherein the topic assessment metric describes treatment of each of multiple topics in the plurality of meeting recording files, and wherein assigning the topic assessment metric includes, for a respective meeting recording file:
generating a vector representation of a portion of the respective meeting recording file;
matching the portion of the respective meeting recording file to a candidate topic based on a similarity metric between the vector representation of the portion and a vector representation of the candidate topic;
applying a scoring model to the portion of the respective meeting recording file, the scoring model when applied configured to output the topic assessment metric for the treatment of the candidate topic for the portion of the meeting recording file;
select a subset of the use data and the plurality of meeting recording files; and
populate the interactive user interface based on the selected subset of the use data and one or more topic assessment metrics associated with the plurality of meeting recording files.

18. The non-transitory computer readable medium of claim 17, wherein assigning the topic assessment metric further includes:
generating a snippet of a first meeting recording file that includes at least the portion of the first meeting recording file;
wherein the snippet is matched to a first candidate topic based on a similarity metric between a vector representation associated with the snippet and a vector representation of the first candidate topic; and
sending the snippet and the first candidate topic to a large language model (LLM) to validate whether the snippet includes a discussion of the first candidate topic by participants in a meeting associated with the first meeting recording file.

19. The non-transitory computer readable medium of claim 17, wherein a second topic of the multiple topics is a specified content item that is presented within a shared screen during a meeting associated with a second meeting recording file, wherein the second meeting recording file includes a plurality of frames of a video recording of the associated meeting, and wherein assigning the topic assessment metric further includes:
accessing a set of frames of the second meeting recording file;
generating, for each respective frame in the set of frames, a vector representation of an image of at least a portion of the respective frame; and
matching an image of a respective frame in the set of frames to a selected content item from a content repository, based on a degree of similarity between (i) the vector representation of the image of the respective frame in the set of frames, and (ii) a vector representation of the selected content item.

20. The non-transitory computer readable medium of claim 17, wherein a meeting recording file of the multiple meeting recording files includes an audio file, a video file, or a transcript.
